(19) United States
(12) Patent Application Publication
(10) Pub. No.: US 2021/0271957 A1
(43) Pub. Date: Sep. 2, 2021

(54) ANOMALY DETECTION USING MACHINE-LEARNING BASED NORMAL SIGNAL REMOVING FILTER

(71) Applicant: Electronics and Telecommunications Research Institute, Daejeon (KR)

(72) Inventors: Gi Young LEE, Daejeon (KR); Byung Bog LEE, Daejeon (KR); Woong Shik YOU, Sejong-si (KR); Cheol Sig PYO, Sejong-si (KR)

(73) Assignee: Electronics and Telecommunications Research Institute, Daejeon (KR)

(21) Appl. No.: 17/174,199

(22) Filed: Feb. 11, 2021

(30) Foreign Application Priority Data
Feb. 27, 2020 (KR) 10-2020-0024675
Jun. 5, 2020 (KR) 10-2020-0068313

(51) Int. Cl. G06N 3/04; G06N 3/08; G06N 20/00; G06N 5/04

(52) U.S. Cl. CPC G06N 3/0454; G06N 5/04; G06N 20/00; G06N 3/08

(57) ABSTRACT

The invention relates to a technology for detecting an abnormal signal using a filter for removing normal sound (or normal signals) around a sensor at normal times. The filter is provided to remove normal sound based on a denoising autoencoder learning technique for removing noise and used to determine whether field sound is an abnormal signal different from that of normal times. The filter is trained to pass normal sound, regarded as noise, to output a value of 0 and pass an abnormal signal without change. The filter is retrained by collecting only normal sound rather than abnormal signals in the field and then adding the collected normal sound to the existing training data. Therefore, even machine-learning nonexperts may easily and conveniently retrain the filter.

### CROSS-REFERENCE TO RELAFED APPLICATION

This application claims priority to and the benefit of Korean Patent Application Nos. 10-2020-0024675, filed on Feb. 7, 2020 and 10-2020-0068313, filed on Jun. 5, 2020, the disclosures of which are incorporated herein by reference in its entirety.

### BACKGROUND

### Field of the Invention

The present invention relates to machine learning technology, signal filtering technology, and anomaly detection (i.e., noise or abnormal signal detection) technology.

### 2. DISCUSSION OF RELATED ART

In real life, various abnormal signals, such as noise, exist. A great deal of research has been conducted on technologies for detecting such abnormal signals. In particular, recently, research on detecting abnormal signals using machine learning is being conducted.

When applying a machine learning-based abnormal signal detection (anomaly detection) model to real life, the main limitation is that it is difficult to collect abnormal signals for learning and abnormal signals are highly diverse. In addition, even when abnormal signals were collected and a machine learning-based model has been trained, when characteristics of signals in an actual field change, the accuracy of detecting the abnormal signals may be degraded, so the machine learning model needs to be retrained by re-collecting signals from the field again.

### SUMMARY OF THE INVENTION

The present invention provides a technology for detecting an abnormal signal using a filter for removing normal sound (or normal signals) around a sensor at normal times.

The technical objectives of the present invention are not limited to the above, and other objectives may become apparent to those of ordinary skill in the art based on the following description.

The present invention devises a filter that removes normal sound based on a denoising autoencoder learning technique for removing noise, and the filter is used to determine whether field sound is an abnormal signal different from that of normal times. The filter is trained to pass normal sound, regarded as noise, to output a value of 0(zero) and pass an abnormal signal without change.

The filter is retrained by collecting only normal sound rather than abnormal signals in the field and then adding the collected normal sound to the existing training data. Therefore, even machine-learning nonexperts may easily and conveniently retrain the filter.

As described above, a filter is introduced that removes a normal signal (normal sound) around a sensor using machine learning and uses the filter to detect abnormal signals.

The filter may be provided to collect normal sound or abnormal signals through a microphone to remove the normal sound while detecting the abnormal signals and may be widely adapted to detecting abnormal signals from data acquired using various sensors (e.g., Inertial Measurement Unit (IMU), a flow sensor, a flow rate sensor, etc.) that measure physical quantities. In other words, a filter may be generated to remove normal vibration by regarding physical quantities of acceleration or angular velocity of an IMU at normal times as normal vibration. Or, a filter may be generated to recognize an abnormal change in flow or flow rate by regarding flow or flow rate at normal times as noise.

The filter is retrained, by additionally collecting normal sound, when the characteristics of normal signals change due to environment changes around the sensor and retraining is needed. Accordingly, the present invention is directed to automation so that even machine-learning nonexperts may easily and conveniently retrain the normal sound removing filter and detect an abnormal signal.

The concept of the present invention introduced above will become more apparent based on specific embodiments described with reference to the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic view illustrating a configuration of an apparatus for detecting an abnormal signal on the basis of machine learning according to the present invention;

FIG. 2 is a schematic view illustrating a configuration of a filter for removing normal sound on the basis of machine learning according to an embodiment of the present invention;

FIG. 3 is a schematic view illustrating a configuration of a filter for removing normal sound on the basis of machine learning according to another embodiment of the present invention;

FIG. 4 is an exemplary view illustrating an example in which the present invention is adapted to a normal signal (normal sound); and

FIG. 5 is an exemplary view illustrating an example in which the present invention is applied to an abnormal signal.

### DETAILED DESCRIPTION OF EXEMPLARY EMBODIMENTS

Hereinafter, the advantages and features of the present invention and ways of achieving them will become readily apparent with reference to descriptions of the following detailed embodiments in conjunction with the accompanying drawings. However, the present invention is not limited to such embodiments and may be embodied in various forms. The embodiments to be described below are provided only to assist those of ordinary skill in the art in fully understanding the scope of the present invention, and the scope of the present invention is defined only by the appended claims.

Terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Hereinafter, exemplary embodiments of the present invention will be described in detail with reference to the accompanying drawings. In the description of the embodiments, a detailed description of related known functions or constructions will be omitted to avoid obscuring the subject matter of the present invention.

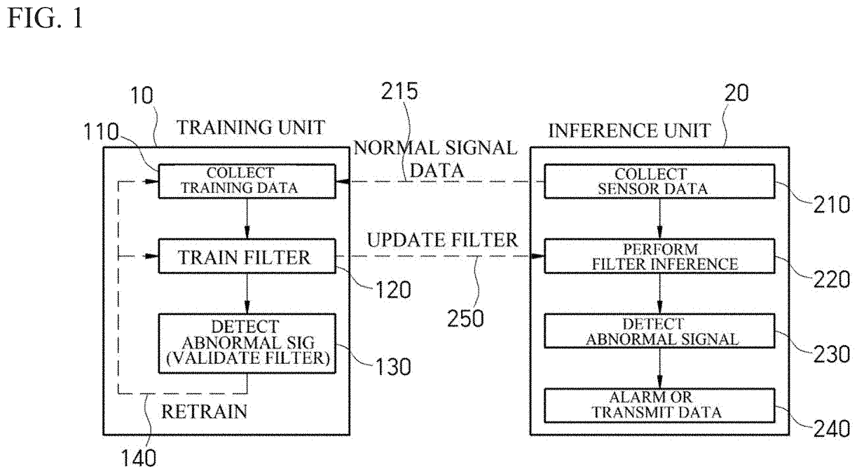

FIG. 1 illustrates the overall configuration of an apparatus for detecting an abnormal signal from sensor data on the basis of machine learning according to the present invention.

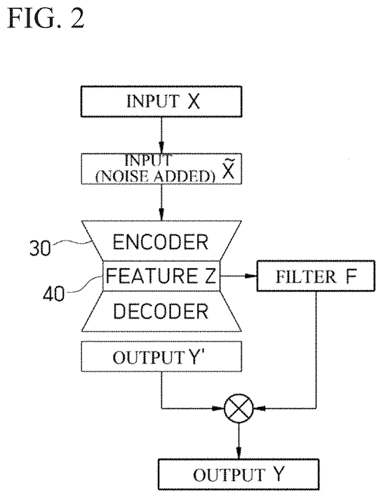

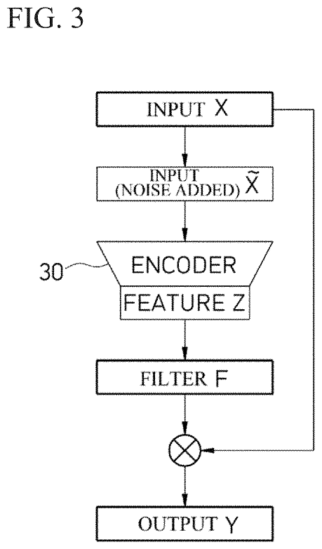

A training unit 10 collects data 215 (e.g., time series data) that is measured and collected by a sensor (e.g., a physical quantity measurement sensor) as training data (110) and trains a filter (see FIGS. 2 and 3) that removes a normal signal while passing an abnormal signal as a machine learning model (120). An inference unit 20 collects data (sensor data.) that is measured by the sensor (210) and performs inference using the filter model trained by the training unit 10 (220) and detects and determines an abnormal signal (230) to issue an alarm to the user or transmit data to the training unit (240). Further, when needed, the training unit 10 periodically collects the sensor data and retrains the filter (140) to perform filter update (250), and the inference unit 20 uses the updated filter to perform a series of processes of detecting an abnormal signal. As described above, the apparatus for detecting an abnormal signal according to the present invention is constructed based on artificial intelligence (M) learning and inference infrastructure so that the apparatus may be easily used by even machine-learning nonexperts.

The embodiment assumes that the training unit 10 is implemented in a server or a cloud computer equipped with a graphic processing unit (GPU), and the inference unit 20 is implemented in an edge device such as a smart phone or a small low-power device. However, the implementation of the training unit 10 and the inference unit 20 is not limited thereto. Details thereof are described below.

Collection of Training Data (110)

The time series data collected from the sensor (210) is pre-processed per predetermined time windows (e.g., one second) and then stored in the form of a file. In this case, in order for the data to be stored together with label information, folders for storing the files may be classified by labels. For example, the folders are classified into noise, a normal signal, an abnormal signal, and the like. In the classification of folders, the folders may be further subdivided into “normal signal and abnormal signal including field noise” and “normal signal and abnormal signal measured in a noise-free environment,” The normal signals and abnormal signals measured in a noise-free environment may be provided with noise added in the training of the filter (120). In a general field, only noise and normal signals may be collected. In this case, abnormal signals may be collected by simulation in a laboratory environment, or some samples of abnormal signals may be artificially generated and used.

The file data stored in each folder serves as an input of the filter model in the training of the filter. The output of the filter model is processed as follows according to the labels. 1) In the case of a normal signal, the output has a value of 0 (zero) with the same shape as the input, and 2) in the case of an abnormal signal, the output has the same value as that of the input.

As such, the output of the training data for the normal signal is processed to have a value of 0 (zero), and the output of the training data for the abnormal signal is processed to have the same value as that of the input using the labels, and the training of the filter is performed as follows.

Training of Filter (120)

The filter for removing noise and normal signals has a configuration illustrated as a graph (architecture) shown in FIG. 2. The configuration is a modified form of an autoencoder. The description of each component is as follows.

An input X is an input signal.

An input \tilde{X} is an input signal in which noise is added. Noise is provided as a randomly generated signal or a signal measured by a sensor, For example, in the case of a speech or acoustic signal measured by a microphone, a signal obtained by measuring noise in the field is added to an input signal measured in a noise-free environment, which may be omitted when the input signal already contains noise.

An encoder 30 is a component that extracts a feature, which may be constructed by combining a convolutional layer, a density layer, etc.

A feature Z refers to a feature generated by the encoder 30.

A decoder 40 is a component that reconstructs the input signal from the feature Z by inversely performing an operation performed by the encoder 30.

Y′ denotes the output that is reconstructed from the input signal by the decoder 40.

A filter F is a dense layer that provides the same dimension as that of the input X from the feature Z. The filter F is implemented using a Sigmoid activation function to have a probability value between 0 and 1.

An output Y is a value obtained by a multiplier's multiplying an output Y′, which is obtained by reconstructing the input signal, by the filter F.

On the other hand, the decoder 40 may be omitted from the apparatus for removing noise and normal signals shown in FIG. 2 to construct a simpler graph (architecture) as shown in FIG. 3. In FIG. 3, instead of multiplying the output from the decoder shown in FIG. 2 by the filter F, the multiplier multiplies the input X by the filter F to generate the output Y.

In the training of the filter for removing noise and normal signals as shown in FIGS. 2 and 3, the filter is trained such that the input X and the output Y become equal to each other using a mean squared error technique as a loss function. In order to effectively remove noise or normal signals, a mean absolute error in which the output Y is 0 may be added to the loss function. Consequently, when the output Y has an estimated value of Ŷ, the loss function is expressed as follows

$$L ( \hat{Y} ) = {{Σ}_{i} ( + z , 999 - + z , 999 )}^{z} ++ z , 999 \vert + z , 999 \vert$$

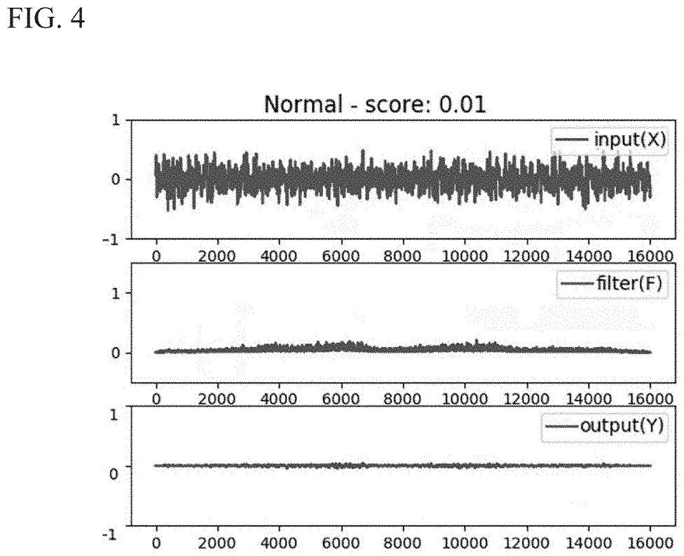

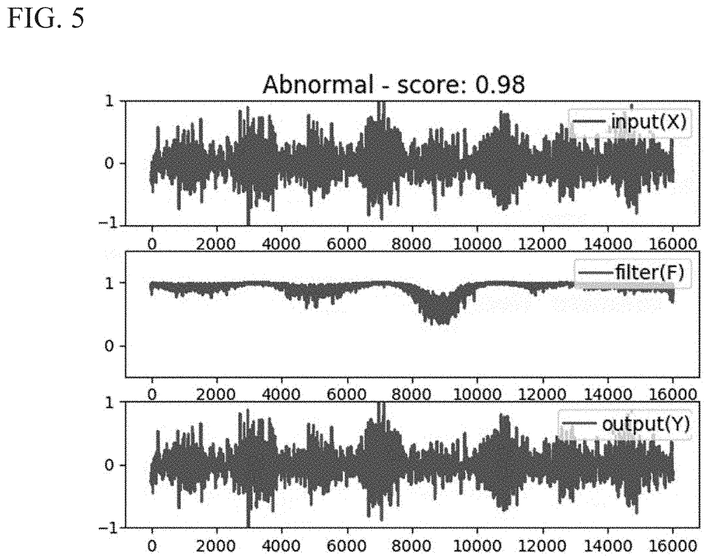

As the filter is trained as described above, the filter F is trained to have a value close to 0 (score=0.01) in the case of a normal signal as shown in FIG. 4 and have a value close to 1 (score=0.98) in the case of an abnormal signal as shown in FIG. 5. In addition, the output Y of the filter model is also caused to have a value close to 0 in the case of noise and normal signals (see FIG. 4) and have a value similar to that of the input in case of an abnormal signal (see FIG. 5).

Detection of Abnormal Signal (130)

An abnormal signal determination value (a score) is calculated using a filter F and an output Y that are inferred by inputting data collected from the sensor into the filter model trained above. For example, through arithmetic operations, such as calculating the average value of the filter F, calculating the average value of the output Y, and calculating the average value of F×Y, a score for finally determining an abnormal signal is calculated. Instead of the average value, the maximum value, the top n average values, and the median value may be used to calculate the score. If the abnormal signal determination value is larger than a specific threshold, an abnormal signal is determined. The threshold may be set, for example, as 0.5, or may be experimentally set. The method of calculating the abnormal signal determination value may also be experimentally selected as a method having high accuracy. FIGS. 4 and 5 illustrate results obtained when the abnormal signal determination value is calculated using the maximum value of F×Y.

After the training of the filter (120) is completed as above, whether the filter is properly trained is validated by calculating the accuracy of abnormal signal detection using sample data. When the accuracy of abnormal signal detection is excessively low, the filter model is retrained by additionally collecting training data. or changing a graph or parameter of the filter model (140).

Inference by Filter (220)

The filter model trained by the server/cloud computer (i.e., the training unit of FIG. 1) is mounted in the edge device (i.e., the inference unit of FIG. 1), in order for the edge device to use the filter model for inference, the edge device receives a graph and parameters of the filter model in the form of a file (e.g., a TensorFlow Lite Model file) and loads the filter model from the file. In this way, when the filter model is retrained (140) and updated (250), only the file needs to be replaced, which enables even a machine-learning nonexpert to update the filter, achieving one of the objectives of the present invention.

The edge device equipped with the filter does not transmit data collected from the sensor to the server/cloud every time (operations 210 and 215 in FIG. 1), but when it is determined in the abnormal signal detection method 130 described above as a case of an abnormal signal (230), issues an alarm to the user or transmits the data to the server/cloud computer (240), and thus data communication costs may be reduced.

On the other hand, the server/cloud computer, when there is a need to perform comprehensive determining on abnormal symptom cases received from the edge device, intensively analyzes only the data notified by alarm, thereby reducing manpower and costs required for monitoring.

Filter Retraining (140) and Filter Update (250)

When it is determined that the accuracy of abnormal signal detection is lowered due to characteristics in noise and normal signals around the sensor, or when it is needed by a user, the titter is retrained by newly collecting noise and normal signals (140). For the retraining, the newly collected noise and normal signals are added to or substituted for the existing training data to fine-tune the filter model. As such, even when the filter is retrained by only adding noise and normal signals without adding abnormal signals, the accuracy of abnormal signal detection may he improved. To this end, the edge device stores normal signals at normal times and transmits the stored normal signals to the training unit 10 when needed.

The present invention may also be adapted to detect abnormal signals in the field of machine failure diagnosis, pipe leak monitoring, and fire monitoring. In an environment in which sensor data may be collected using a physical quantity measurement sensor (a microphone, an Inertial Measurement Unit (IMU), a flow sensor, a flow rate sensor, etc.), abnormal signals, which rarely occur, are not easily collected but detection of abnormal signals different from normal signals may be performed by collecting noise and normal signals. Since a human does not need to continuously perform monitoring and only needs to check when an abnormal signal is detected, the cost for monitoring may be reduced. In addition, since the existing machine learning-based model is mainly executed on the server cloud computer, the edge device needs to transmit sensor data to the server/cloud computer every time. However, according to the present invention, the edge device performs abnormal signal detections and, only when an abnormal signal is determined to exist, transmits information about recognizing the related situation and original sensor data used at the time of the recognition of the situation to the server, thereby reducing the communication and related costs.

A function or process of each element of the present invention described above may be implemented in a hardware component including at least one of a digital signal processor (DSP), a processor, a controller, an application-specific IC (ASIC), a programmable logic device (e.g., a field programmable gate array (FPGA)), etc.), other electronic devices, or a combination thereof, or may be implemented in software alone or in combination with the hardware component, wherein the software may be stored in a recording medium.

As is apparent from the above, according the present invention, abnormal signals are detected by mounting a trained filter in an edge device, and a signal is not transmitted every time but is transmitted only when an abnormal signal is determined, and thus the communication cost required for data transmission can be reduced. In addition, because the monitoring time is reduced, the cost required for monitoring personnel can be reduced.

Although the present invention has been described with reference to the embodiments, a person of ordinary skill in the art should appreciate that various modifications, equivalents, and other embodiments are possible without departing from the scope and spirit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

What is claimed is:

1. An apparatus for detecting an abnormal signal using a filter for removing normal signals on the basis of machine-learning, the apparatus comprising:
a training unit configured to collect sensor data measured and collected by a sensor as training data, and train a filter model that removes noise and normal signals and passes abnormal signals from the collected training data as a machine learning model; and
an inference unit configured to collect the sensor data to perform abnormal signal detection using the filter model trained by the training unit.

2. The apparatus of claim 1, wherein:
the training unit is further configured to reflect newly collected noise and normal signals in the training data according to a result of validating the filter model by performing the abnormal signal detection using the trained filter model to retrain the filter model, and
the inference unit is further configured to perform inference and abnormal signal detection using the retrained filter model.

3. The apparatus of claim I, wherein the training unit is implemented in a server or a cloud computer, and the inference unit is implemented in an edge device.

4. The apparatus of claim 1, wherein the filter model comprises:
an encoder configured to extract a feature from a signal that is an input having noise added thereto;
a filter configured to generate a filter value having same dimension as the input from the feature generated by the encoder;
a decoder configured to inversely perform an operation performed by the encoder to reconstruct an input signal from the feature; and
a multiplier configured to multiply the signal reconstructed by the decoder by the filter value to obtain an output.

5. The apparatus of claim 1, wherein the filter model comprises:
an encoder configured to extract a feature from a signal that is an input having noise added thereto;
a filter configured to generate a filter value having same dimension as the input from the feature generated by the encoder; and
a multiplier configured to multiply the input by the filter value to obtain an output.

6. The apparatus of claim 1. wherein, when the filter model is trained, a label is used to process an output of the training data regarding the normal signal to have a value of 0 and process an output of the training data regarding the abnormal signal to have the same value as an input, and the filter model is trained using a loss function such that the input becomes equal to the output.

7. The apparatus of claim 1, wherein the abnormal signal detection by the inference unit comprises
calculating an abnormal signal determination value using a filter value and an output value, which are inferred by inputting the sensor data into the trained filter model, and
determining the abnormal signal when the abnormal signal determination value is greater than or equal to a specific threshold value.

8. The apparatus of claim 2, wherein the abnormal signal detection by the inference unit comprises
calculating an abnormal signal determination value using a filter value and an output value, which are inferred by inputting the sensor data into the trained filter model, and
determining the abnormal signal when the abnormal signal determination value is greater than or equal to a specific threshold value.

9. The apparatus of claim 1, wherein the inference unit is configured to
receive the filter model in a form of a file from the training unit, and
load the filter model from the received file to use the filter model trained by the training unit.

10. The apparatus of claim 1. wherein the inference unit is further configured to
perform inference and abnormal signal detection using the filter model, and, when an abnormal signal is detected, perform at least one of alarm issuing and transmission of data to the training unit.

11. The apparatus of claim 10, wherein the training unit is further configured to analyze the data received from the inference unit.

12. The apparatus of claim 10, wherein the data transmitted to the training unit comprises, when the abnormal signal is detected by the inference unit, recognition information of an abnormal situation that is detected and original sensor data used at a time of recognition of the abnormal situation.

13. A machine-learning based noise and normal signal removing filter having a filter model used by an abnormal signal detecting apparatus, including a training unit configured to collect sensor data measured and collected by a sensor as training data and train the filter model that removes noise and normal signals and passes abnormal signals from the collected training data as a machine learning model; and an inference unit configured to collect the sensor data to perform abnormal signal detection using the filter model trained by the training unit, the filter model comprising:
an encoder configured to extract a feature from a signal that is an input having noise added thereto;
a filter configured to generate a filter value having the same dimension as the input from the feature generated by the encoder;
a decoder configured to inversely perform an operation performed by the encoder to reconstruct an input signal from the feature; and
a multiplier configured to multiply the input signal reconstructed by the decoder by the filter value to obtain an output.

14. The filter of claim 13, wherein the noise included in the signal that is an input having noise added thereto is one of a randomly generated signal and a signal measured by the sensor.

15. The filter of claim 13, wherein the filter comprises an activation function having a value in a range of 0 to 1.

16. The filter of claim 13, wherein, when the filter model is trained, a label is used to process the output of the training data regarding the normal signal to have a value of 0 and process the output of the training data regarding the abnormal signal to have the same value as an input, and the filter model is trained using a loss function such that the input becomes equal to the output.

17. A machine-learning based noise and normal signal removing filter having a filter model used by an abnormal signal detecting apparatus, including a training unit configured to collect sensor data measured and collected by a sensor as training data and train the filter model that removes noise and normal signals and passes abnormal signals from the collected training data as a machine learning model; and an inference unit configured to collect the sensor data to perform abnormal signal detection using the filter model trained by the training unit, the filter model comprising:
an encoder configured to extract a feature from a signal that is an input having noise added thereto;
a filter configured to generate a filter value having the same dimension as the input from the feature generated by the encoder; and
a multiplier configured to multiply the input reconstructed by the decoder by the filter value to obtain an output.

18. The filter of claim 17, wherein the noise included in the signal that is an input having noise added thereto is one of a randomly generated signal and a signal measured by the sensor.

19. The filter of claim 17, wherein the filter comprises an activation function having a value in a range of 0 to 1.

20. The filter of claim 17, wherein, when the filter model is trained, a label is used to process the output of the training data regarding the normal signal to have a value of 0 and process the output of the training data regarding the abnormal signal to have the same value as an input, and tine filter model is trained using a loss function such that the input becomes equal to the output.
